(19) United States
(12) Patent Application Publication
(10) Pub. No.: US 2026/0175685 A1
(43) Pub. Date: Jun. 25, 2026

(54) DRIVING ASSISTANCE DEVICE, DRIVING ASSISTANCE METHOD, AND NON-TRANSITORY COMPUTER-READABLE STORAGE MEDIUM

(71) Applicant: HONDA MOTOR CO., LTD., Tokyo (JP)

(72) Inventors: Kenjiro TORII, Saitama (JP); Kiri YOSHIDA, Saitama (JP); Kohei MATSUDA, Saitama (JP); Shigenobu SAIGUSA, Tokyo (JP); Youngjun AN, Tokyo (JP)

(21) Appl. No.: 19/407,846

(22) Filed: Dec. 3, 2025

(30) Foreign Application Priority Data
Dec. 24, 2024 (JP) 2024-227760

(51) Int. Cl. B60K 35/22; B60K 35/60; B60W 30/18; B60W 50/14

(52) U.S. Cl. CPC B60K 35/22; B60K 35/60; B60W 30/18163; B60W 50/14; B60K 2360/1868; B60K 2360/794; B60W 2050/143; B60W 2050/146

(57) ABSTRACT

A driving assistance device for a vehicle includes: a display device provided in a cabin of the vehicle and extending in a predetermined direction, the display device having multiple display regions divided in an extension direction; and a control device that controls the display device. The control device is configured to: acquire, on a merging lane that merges with a main lane, a position of the vehicle with respect to a merging start point where a lane change from the merging lane to the main lane becomes possible; and cause at least one of the multiple display regions to emit light based on the position of the vehicle with respect to the merging start point, such that as the position of the vehicle approaches the merging start point, the at least one display region that emits light shifts in the extension direction.

### TECHNICAL FIELD

The present invention relates to a driving assistance device, a driving assistance method, and a control program (stored in a non-transitory computer-readable storage medium).

### BACKGROUND ART

In recent years, there has been an increase in efforts to provide sustainable transportation systems that take into account people in vulnerable situations among traffic participants. To realize this, research and development related to driving assistance technology and autonomous driving technology are conducted to further improve the safety and convenience of traffic.

WO2007/026748A1 discloses a driving assistance device that displays, on a monitor of a vehicle traveling in a merging preparation section of a merging lane that merges with a main lane, map information and a numerical value representing the distance to the merging point, thereby to prompt the driver to prepare for merging.

However, on the merging lane, the driver needs to monitor the preceding and following vehicles on the merging lane as well as the vehicles on the main lane while accelerating the vehicle. Therefore, it may be difficult for the driver to check the monitor of the vehicle. Further, in the case where the merging lane is curved, the driver needs to perform steering operations, and this makes it even more difficult to confirm the numerical information on the monitor.

### SUMMARY OF THE INVENTION

In view of the foregoing background, an object of one aspect of the present invention is to provide a driving assistance device, a driving assistance method, and a control program that can allow the driver to easily recognize the distance from the vehicle to the merging start point when the vehicle is in the merging preparation section.

To achieve the above object, one aspect of the present invention provides a driving assistance device for a vehicle, the driving assistance device comprising: a display device provided in a cabin of the vehicle and extending in a predetermined direction, the display device having multiple display regions divided in an extension direction; and a control device that controls the display device, wherein the control device is configured to: acquire, on a merging lane that merges with a main lane, a position of the vehicle with respect to a merging start point where a lane change from the merging lane to the main lane becomes possible; and cause at least one of the multiple display regions to emit light based on the position of the vehicle with respect to the merging start point, such that as the position of the vehicle approaches the merging start point, the at least one display region that emits light shifts in the extension direction.

Another aspect of the present invention provides a driving assistance method for a vehicle, wherein the driving assistance method is to be executed by a computer, wherein a display device extending in a predetermined direction is provided in a cabin of the vehicle, the display device having multiple display regions divided in an extension direction, the driving assistance method comprising: acquiring, on a merging lane that merges with a main lane, a position of the vehicle with respect to a merging start point where a lane change from the merging lane to the main lane becomes possible; and causing at least one of the multiple display regions to emit light based on the position of the vehicle with respect to the merging start point, such that as the position of the vehicle approaches the merging start point, the at least one display region that emits light shifts in the extension direction.

Another aspect of the present invention provides a non-transitory computer-readable storage medium, comprising a stored control program, the control program configured to cause a computer to execute a driving assistance method for a vehicle, wherein a display device extending in a predetermined direction is provided in a cabin of the vehicle, the display device having multiple display regions divided in an extension direction, the driving assistance method comprising: acquiring, on a merging lane that merges with a main lane, a position of the vehicle with respect to a merging start point where a lane change from the merging lane to the main lane becomes possible, causing at least one of the multiple display regions to emit light based on the position of the vehicle with respect to the merging start point, such that as the position of the vehicle approaches the merging start point, the at least one display region that emits light shifts in the extension direction.

According to the above aspects of the present invention, a driving assistance device, a driving assistance method, and a control program that can allow the driver to easily recognize the distance from the vehicle to the merging start point when the vehicle is in the merging preparation section can be provided.

### BRIEF DESCRIPTION OF THE DRAWINGS

FIG. 1 is a configuration diagram of a driving assistance device according to an embodiment;

FIG. 2 is an explanatory diagram of a merging lane;

FIG. 3 is a perspective view showing a cabin of a vehicle;

FIGS. 4A to 4C are explanatory diagrams showing transition of a state of a display device;

FIG. 5 is a flowchart showing a procedure of driving assistance control executed by a control device; and

FIG. 6 is a perspective view showing a cabin of a vehicle according to a modification.

### DETAILED DESCRIPTION OF THE INVENTION

In the following, embodiments of a driving assistance device, a driving assistance method, and a control program will be described with reference to the drawings.

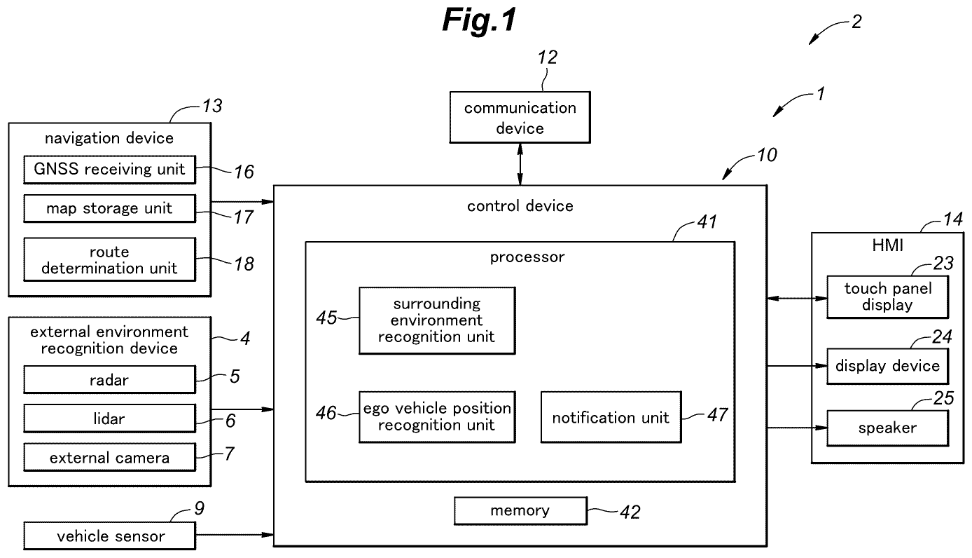

As shown in FIG. 1, a driving assistance device 1 is provided in a vehicle 2. The vehicle 2 may be a four-wheeled automobile, for example.

The driving assistance device 1 includes an external environment recognition device 4. The external environment recognition device 4 is a device that detects objects outside the vehicle 2. The external environment recognition device 4 is a sensor that detects objects or the like outside the vehicle 2 by capturing electromagnetic waves or light from the surroundings of the vehicle 2. The external environment recognition device 4 includes a radar 5, a lidar 6, and an external camera 7, for example.

The driving assistance device 1 includes a vehicle sensor 9. The vehicle sensor 9 includes a vehicle speed sensor that detects the speed of the vehicle 2 and an acceleration sensor that detects the acceleration of the vehicle 2. The vehicle sensor 9 may include a yaw rate sensor that detects an angular velocity around a vertical axis, a direction sensor that detects the direction of the vehicle 2, etc.

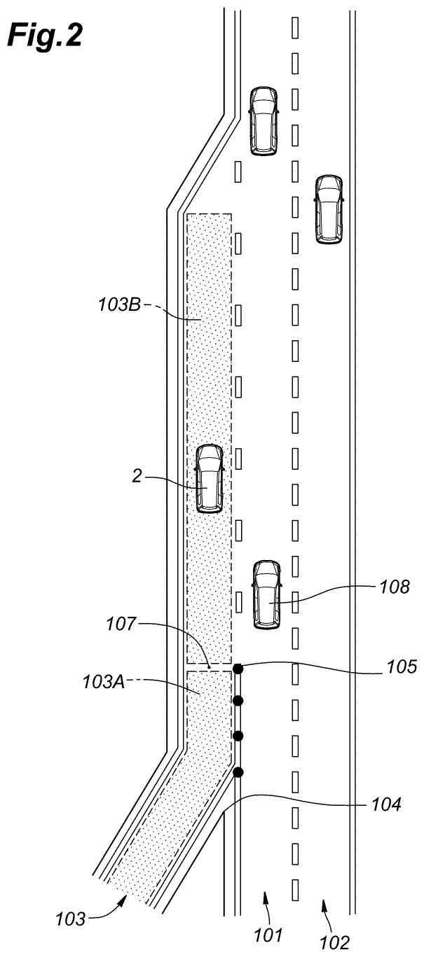

The driving assistance device 1 includes a control device 10, a communication device 12, a navigation device 13, and a human machine interface (HMI) 14. The communication device 12 mediates the communication of the control device 10 and the navigation device 13 with nearby vehicles 108 (see FIG. 2) and a server located outside the vehicle 2.

The navigation device 13 is a device that acquires the current position of the vehicle 2 and provides route guidance to the destination and other functions. The navigation device 13 preferably includes a global navigation satellite system (GNSS) receiving unit 16, a map storage unit 17, and a route determination unit 18. The GNSS receiving unit 16 identifies the position (latitude and longitude) of the vehicle 2 based on signals received from artificial satellites (positioning satellites). The map storage unit 17 is composed of a known storage device such as a flash memory or a hard disk and stores map information.

The map information includes road information which includes types of roads such as expressways, toll roads, national highways, and prefectural roads, the number of lanes of each road, the center position (three-dimensional coordinate including a longitude, a latitude, and a height) of each lane, shapes of road markings such as road delimiting lines and lane boundaries, presence or absence sidewalks, curbs, fences, etc., intersection positions, positions of merging and branching points of each lane, positions of emergency parking zones, the width of each lane, signs provided on the roads, and so on. Also, map information may include traffic regulation information, address information (address and post code), facility information, telephone number information, and so on.

In the present embodiment, the map information includes information on whether the road is a main lane 101, 102 or a merging lane 103 that merges with the main lane 101. As shown in FIG. 2, the merging lane 103 includes a merging preparation section 103A and a mergeable section 103B. The mergeable section 103B extends in parallel with the main lane 101. The vehicle 2 can change lanes into the main lane 101 in the mergeable section 103B. The merging preparation section 103A is separated from the main lane 101 by a hard nose 104, such as walls, and a soft nose 105, such as traffic poles. The beginning point of the mergeable section 103B, namely, the ending point of the merging preparation section 103A is referred to as a merging start point 107. Namely, from the merging start point 107, the mergeable section 103B begins and the vehicle 2 becomes able to change lanes into the main lane 101. The merging start point 107 is preferably set at the ending point of the soft nose 105.

The merging preparation section 103A is an entrance ramp of an expressway, for example. The beginning point of the merging preparation section 103A is a preset arbitrary point. In the case where the merging lane 103 is an entrance ramp of an expressway, for example, the beginning point of the merging preparation section 103A may be the beginning point of the entrance ramp, a toll gate, or a branching point after passing the toll gate.

As information related to the merging lane 103, the map information preferably includes information on whether the merging lane 103 is the merging preparation section 103A or the mergeable section 103B, the position of the beginning point of the merging preparation section 103A, the position of the merging start point 107 (the position of the ending point of the merging preparation section 103A), the length of the merging preparation section 103A, the gradient at various points in the merging preparation section 103A, and the radius of curvature or the curve radius (R) of the merging preparation section 103A.

The HMI 14 notifies the occupant of various kinds of information by display and/or voice and receives input operations performed by the occupant. As shown in FIG. 1, the HMI 14 preferably includes a touch panel display 23 including a liquid crystal display, an organic EL display, or the like, a display device 24, and a speaker 25.

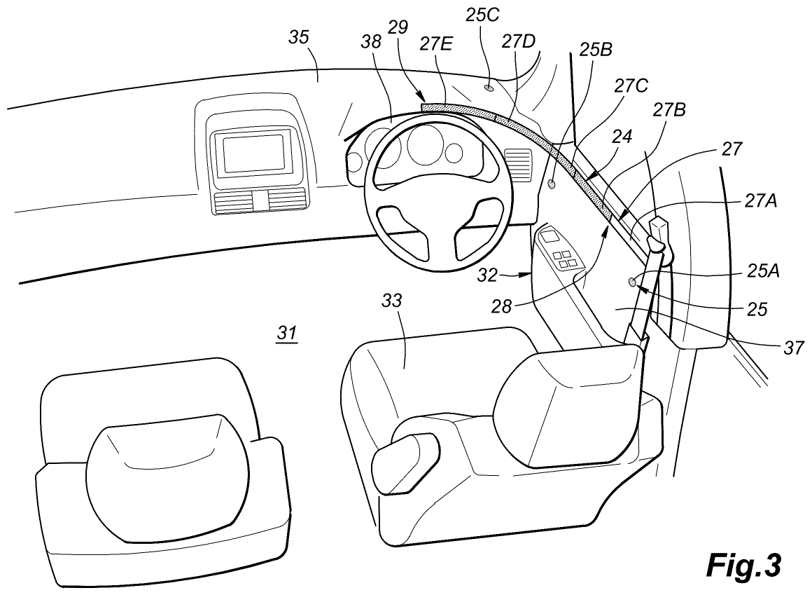

The display device 24 is an optical device for visually providing information to the driver. The display device 24 may be composed of light emitting elements (light sources) such as light emitting diodes (LEDs) or a liquid crystal display. The display device 24 may be a so-called ambient light. As shown in FIG. 3, the display device 24 is provided in the cabin 31 of the vehicle 2 and extends in a predetermined direction. The display device 24 has multiple display regions 27 divided in the extension direction thereof.

In the present embodiment, the display device 24 includes a first part 28 and a second part 29. The first part 28 is provided on a door 32 constituting a side portion of the cabin 31 and extends in the front-rear direction. The door 32 is disposed on a side of the driver's seat 33. The second part 29 is provided on an instrument panel 35 constituting a front portion of the cabin 31 and extends laterally. The front end of the first part 28 and the right end, which is one end, of the second part 29 are disposed close to each other. Thereby, the second part 29 extends leftward from the front end of the first part 28. Preferably, the first part 28 and the second part 29 extend linearly in a continuous manner.

The first part 28 preferably extends in the front-rear direction in an upper portion of a door lining 37 of the door 32. The second part 29 is preferably provided along an upper edge of a meter panel 38 provided in the instrument panel 35. The left end of the second part 29 is preferably disposed above the central part of the meter panel 38.

The first part 28 has multiple display regions 27 divided in the front-rear direction. The second part 29 has multiple display regions 27 divided in the lateral direction. In the present embodiment, the first part 28 includes three display regions 27 arranged in the front-rear direction, and the second part 29 includes two display regions 27 arranged in the lateral direction. The display regions 27 in the first part 28 are referred to as a first display region 27A, a second display region 27B, and a third display region 27C in order from the rear. The display regions 27 in the second part 29 are referred to as a fourth display region 27D and a fifth display region 27E in order from the right. The first to fifth display regions 27A to 27E can emit light independently from each other and can change at least one of color and brightness.

The display device 24 may be provided in a left side portion of the cabin 31. Preferably, the display device 24 on the left side is formed as a mirror image of the display device 24 on the right side.

The speaker 25 includes a first speaker 25A, a second speaker 25B, and a third speaker 25C. The first to third speakers 25A to 25C are arranged at an interval in the front-rear direction in the cabin 31 of the vehicle 2. The second speaker 25B is disposed forward of the first speaker 25A, and the third speaker 25C is disposed forward of the second speaker 25B. The first speaker 25A is preferably provided in a rear portion of the door lining 37 of the door 32 corresponding to the driver's seat 33. The second speaker 25B is preferably provided in a front portion of the door lining 37 of the door 32 corresponding to the driver's seat 33. The third speaker 25C is preferably provided in the instrument panel 35.

As shown in FIG. 1, the control device 10 is a computer including a processor 41 and a memory 42 communicatively connected to the processor 41. The processor 41 preferably includes, as a core, at least one of a central processing unit (CPU), a graphics processing unit (GPU), and a reduced instruction set computer (RISC), for example. The memory 42 stores a control program executed by the processor 41 and various data. The memory 42 preferably includes at least one of a volatile memory and a non-volatile memory. The volatile memory may be a dynamic random access memory (DRAM) or a static random access memory (SRAM), for example. The non-volatile memory may be a solid state drive (SSD), a flash memory, a magnetic disk storage device, or an optical disk storage device. At least a part of the control device 10 may be realized by hardware such as a large scale integration (LSI) circuit, an application specific integrated circuit (ASIC), or a field-programmable gate array (FPGA) or may be realized by a combination of software and hardware. The control device 10 may be composed of one piece of hardware or may be composed of multiple pieces of hardware capable of communicating with each other. A part of the control device 10 may be configured by an external server provided outside the vehicle 2.

The processor 41 implements various applications by executing the control program stored in the memory 42. The control program may be stored in a removable recordable medium such as a DVD or a CD-ROM and may be installed into the memory 42 when the recordable medium is read by a reading device. Also, the control program may be downloaded via a communication network such as the internet and installed into the memory 42.

The control device 10 controls the display device 24 and the first to third speakers 25A to 25C. By executing the control program stored in the memory 42, the processor 41 functions as a surrounding environment recognition unit 45, an ego vehicle position recognition unit 46, and a notification unit 47.

The surrounding environment recognition unit 45 recognizes the surrounding environment of the vehicle 2. The surrounding environment recognition unit 45 recognizes, based on the detection result of the external environment recognition device 4, the surrounding environment (external environment) including obstacles present around the vehicle 2, road shape, lane markings, presence or absence of sidewalks, road markings, etc. The obstacles include guardrails, utility poles, nearby vehicles 108 (see FIG. 2), and persons such as pedestrians, for example. The surrounding environment recognition unit 45 can acquire a state, such as the position, velocity, and acceleration of each nearby vehicle 108 from the detection result of the external environment recognition device 4.

The ego vehicle position recognition unit 46 recognizes the position of the vehicle 2 (ego vehicle). The ego vehicle position recognition unit 46 preferably recognizes the position of the vehicle 2 based on the GNSS signal received by the GNSS receiving unit 16.

The notification unit 47 executes driving assistance control when the vehicle 2 is in the merging preparation section 103A of the merging lane 103. The notification unit 47 determines whether the vehicle 2 is in the merging preparation section 103A of the merging lane 103 based on the position of the vehicle 2 acquired by the ego vehicle position recognition unit 46 and the map information. In the driving assistance control, the notification unit 47 of the control device 10 causes at least one of the multiple display regions 27 to emit light based on the position of the vehicle 2 with respect to the merging start point 107, such that as the position of the vehicle 2 approaches the merging start point 107, the at least one display region 27 that emits light shifts in the extension direction. In the present embodiment, the notification unit 47 of the control device 10 causes the at least one display region 27 that emits light to shift toward the front side as the position of the vehicle 2 approaches the merging start point 107. Also, the notification unit 47 of the control device 10 causes the at least one display region 27 that emits light to shift toward the front side in the first part 28 as the position of the vehicle 2 approaches the merging start point 107, and after the at least one display region 27 that emits light reaches the front end of the first part 28, the notification unit 47 causes the at least one display region 27 that emits light to shift toward the lateral center of the vehicle 2 in the second part 29 as the position of the vehicle 2 approaches the merging start point 107.

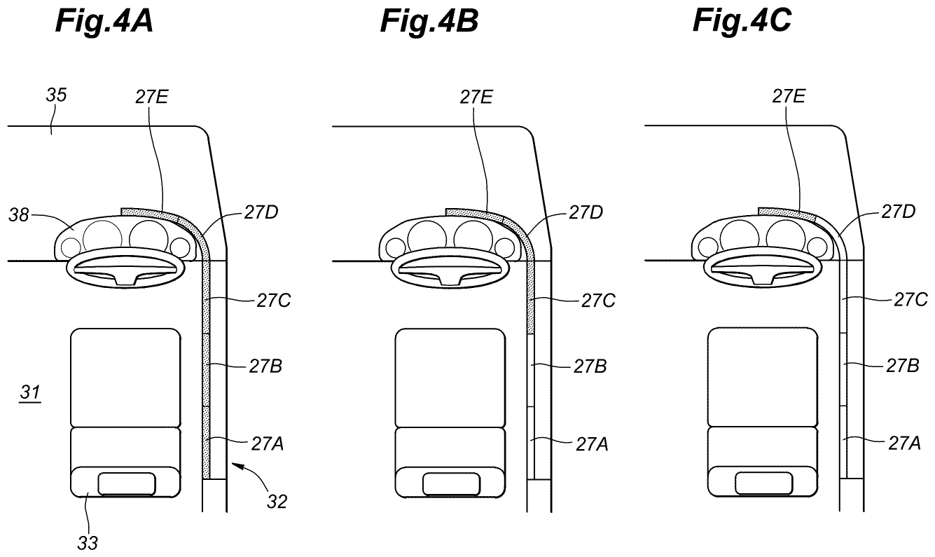

Preferably, the notification unit 47 calculates the remaining distance to the merging start point 107 along the merging preparation section 103A based on the position of the vehicle 2 and the merging start point 107, and determines at least one display region 27 that emits light depending on the remaining distance. For example, preferably, the notification unit 47 causes the first to fifth display regions 27A to 27E to emit light when the remaining distance is greater than or equal to a first threshold, causes the second to fifth display regions 27B to 27E to emit light when the remaining distance is greater than or equal to a second threshold, which is set to a value smaller than the first threshold, and is less than the first threshold, causes the third to fifth display regions 27C to 27E to emit light when the remaining distance is greater than or equal to a third threshold, which is set to a value smaller than the second threshold, and is less than the second threshold, causes the fourth and fifth display regions 27D and 27E to emit light when the remaining distance is greater than or equal to a fourth threshold, which is set to a value smaller than the third threshold, and is less than the third threshold, and causes the fifth display region 27E to emit light when the remaining distance is greater than or equal to a fifth threshold, which is set to a value smaller than the fourth threshold, and is less than the fourth threshold. FIGS. 4A to 4C are explanatory diagrams showing the relationship between the remaining distance and at least one display region 27 that emits light. FIG. 4A shows a state in which the remaining distance is greater than or equal to the first threshold, and the first to fifth display regions 27A to 27E emit light. FIG. 4B shows a state in which the remaining distance is greater than or equal to the third threshold and is less than the second threshold, and the third to fifth display regions 27C to 27E emit light. FIG. 4C shows a state in which the remaining distance is greater than or equal to the fifth threshold and is less than the fourth threshold, and the fifth display region 27E emits light. As shown in FIGS. 4A to 4C, the display device 24 conveys the remaining distance to the driver visually and intuitively with the length of the display regions 27 emitting light.

Also, the notification unit 47 may cause the first display region 27A to emit light when the remaining distance is greater than or equal to the first threshold, cause the second display region 27B to emit light when the remaining distance is greater than or equal to the second threshold and is less than the first threshold, cause the third display region 27C to emit light when the remaining distance is greater than or equal to the third threshold and is less than the second threshold, cause the fourth display region 27D to emit light when the remaining distance is greater than or equal to the fourth threshold and is less than the third threshold, and cause the fifth display region 27E to emit light when the remaining distance is greater than or equal to the fifth threshold and is less than the fourth threshold. Namely, the display device 24 conveys the remaining distance to the driver visually and intuitively with the position of the display region 27 emitting light.

Also, the notification unit 47 may cause the first to fifth display regions 27A to 27E to emit light in a first emission color when the remaining distance is greater than or equal to the first threshold, cause the second to fifth display regions 27B to 27E to emit light in the first emission color and the first display region 27A to emit light in a second emission color when the remaining distance is greater than or equal to the second threshold and is less than the first threshold, cause the third to fifth display regions 27C to 27E to emit light in the first emission color and the first and second display regions 27A and 27B to emit light in the second emission color when the remaining distance is greater than or equal to the third threshold and is less than the second threshold, cause the fourth and fifth display regions 27D and 27E to emit light in the first emission color and the first to third display regions 27A to 27C to emit light in the second emission color when the remaining distance is greater than or equal to the fourth threshold and is less than the third threshold, and cause the fifth display region 27E to emit light in the first emission color and the first to fourth display regions 27A to 27D to emit light in the second emission color when the remaining distance is greater than or equal to the fifth threshold and is less than the fourth threshold. The first emission color and the second emission color are different emission colors from each other. For example, the first emission color may be red, and the second emission color may be blue. The display device 24 conveys the remaining distance to the driver visually and intuitively by the length of the display regions 27 emitting light in the first emission color.

The notification unit 47 may calculate a remaining ratio by dividing the remaining distance by the length of the merging preparation section 103A, and may determine the at least one display region 27 that emits light depending on the remaining ratio instead of the remaining distance.

The notification unit 47 of the control device 10 may change at least one of the color and brightness of the light emitted from the first to fifth display regions 27A to 27E based on at least one of the radius of curvature and the gradient of the merging preparation section 103A. For example, the notification unit 47 may cause the first to fifth display regions 27A to 27E to emit light in red when the radius of curvature of the merging preparation section 103A is less than or equal to a predetermined determination value, and may cause the first to fifth display regions 27A to 27E to emit light in blue when the radius of curvature is greater than the determination value. Also, for example, the notification unit 47 may change the emission color of light emitted from the first to fifth display regions 27A to 27E from bluish to reddish as the radius of curvature of the merging preparation section 103A becomes smaller. Also, the notification unit 47 may cause the first to fifth display regions 27A to 27E to emit light in red when the downward gradient of the merging preparation section 103A is greater than or equal to a predetermined determination value, and may cause the first to fifth display regions 27A to 27E to emit light in blue when the downward gradient is smaller than the determination value.

The notification unit 47 of the control device 10 selects, based on the position of the vehicle 2 with respect to the merging start point 107, a speaker 25 that outputs a notification sound from among the multiple speakers 25, such that the speaker 25 disposed closer to the front side is selected as the position of the vehicle 2 approaches the merging start point 107. Specifically, the notification unit 47 preferably determines the speaker 25 that outputs the notification sound depending on the remaining distance. The notification sound may be a beep or a buzzing sound generated by a buzzer, for example. Preferably, as the remaining distance decreases, the notification unit 47 causes the speaker 25 closer to the front side to output the notification sound. For example, the notification unit 47 may cause the first speaker 25A to output the notification sound when the remaining distance is greater than or equal to the first threshold, may cause the second speaker 25B to output the notification sound when the remaining distance is greater than or equal to the third threshold and is less than the first threshold, and may cause the third speaker 25C to output the notification when the remaining distance is greater than or equal to the fifth threshold and is less than the third threshold. Namely, the display device 24 conveys the remaining distance to the driver aurally and intuitively with the output position of the notification sound. The notification unit 47 may determine the speaker 25 that outputs the notification sound depending on the remaining ratio instead of the remaining distance.

The notification unit 47 of the control device 10 may change the mode of the notification sound based on at least one of the radius of curvature and the gradient of the merging preparation section 103A. Preferably, the smaller the radius of curvature of the merging preparation section 103A becomes, the notification unit 47 changes the notification sound to one with a greater sense of urgency. Also preferably, the greater the downward gradient of the merging preparation section 103A becomes, the notification unit 47 changes the notification sound to one with a greater sense of urgency. For example, the sense of urgency provided by the notification sound may be preferably changed by shortening the output duration of the notification sound or by increasing the volume of the notification sound.

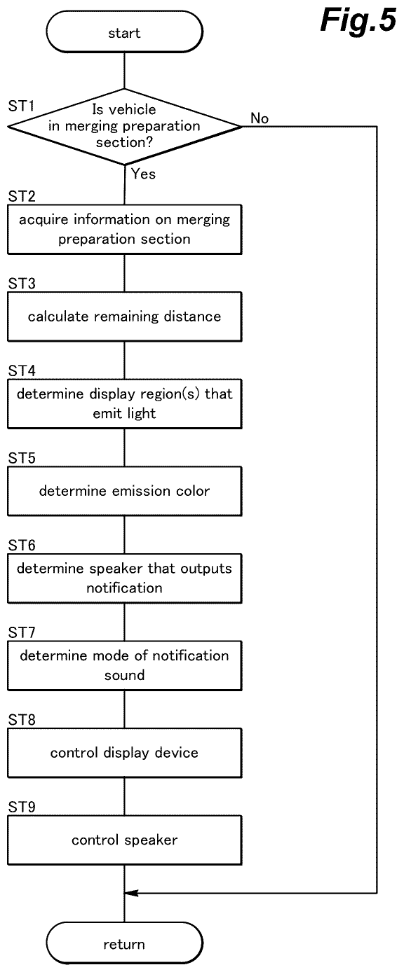

In the following, the control procedure of the driving assistance control executed by the control device 10 will be described. The control device 10 repeatedly executes the driving assistance control shown in FIG. 5 at a predetermined time interval. First, the control device 10 determines whether the vehicle 2 is in the merging preparation section 103A based on the position of the vehicle 2 acquired by the ego vehicle position recognition unit 46 and the map information (ST1). In the case where the vehicle 2 is not in the merging preparation section 103A (ST1: No), the process proceeds to “return” and the driving assistance control is repeated from step ST1.

In the case where the vehicle 2 is in the merging preparation section 103A (ST1: Yes), the control device 10 acquires the information on the merging preparation section 103A based on the map information (ST2). The information on the merging preparation section 103A includes the position of the merging start point 107 and the radius of curvature of the merging preparation section 103A. Also, the information on the merging preparation section 103A may include the length of the merging preparation section 103A.

Next, the control device 10 calculates the remaining distance of the vehicle 2 to the merging start point 107 based on the position of the vehicle 2 and the information on the merging preparation section 103A (ST3).

Next, the control device 10 determines at least one display region 27 that emits light based on the remaining distance (ST4). Preferably, as the remaining distance decreases, the control device 10 reduces the length of the at least one display region 27 that emits light toward the front side. As described above, preferably, the control device 10 compares the remaining distance with a predetermined determination value, and determines the at least one display region 27 that emits light.

Next, the control device 10 determines the emission color of the at least one display region 27 that emits light based on the radius of curvature of the merging preparation section 103A (ST5). Preferably, the smaller the radius of curvature becomes, the control device 10 makes the emission color more reddish, for example.

Next, the control device 10 determines the speaker 25 that outputs the notification sound based on the remaining distance (ST6). The control device 10 causes the speaker 25 that is disposed closer to the front side to output the notification sound as the remaining distance decreases.

Next, the control device 10 determines the mode of the notification sound outputted from the speaker 25 based on the radius of curvature of the merging preparation section 103A (ST7). Preferably, the smaller the radius of curvature becomes, the control device 10 changes the notification sound to one with a greater sense of urgency.

Next, the control device 10 controls the display device 24 based on the at least one display region 27 that emits light determined in step ST4 and the emission color determined in step ST5 (ST8). Thereby, the display device 24 causes the determined display region 27 to emit light with the determined emission color.

Next, the control device 10 controls the speaker 25 determined in step ST6 so as to output the notification sound in the mode determined in step ST7 (ST9).

With the control device 10 executing the driving assistance method, when the vehicle 2 is in the merging preparation section 103A, the at least one display region 27 that emits light changes depending on the remaining distance, which is the distance between the vehicle 2 and the merging start point 107. Specifically, as the vehicle 2 approaches the merging start point 107, the at least one display region 27 that emits light changes to those closer to the front side. By seeing the at least one display region 27 that emits light, the driver can easily recognize the remaining distance. As a result, the driver can recognize the remaining distance and make preparation for merging, such as acceleration of the vehicle 2.

When the vehicle 2 is near the merging start point 107, the at least one display region 27 that emits light changes in the second part 29. Namely, when the remaining distance has become small, the at least one display region 27 that emits light changes in front of the driver, and therefore, the driver can more reliably recognize that the merging start point 107 is close.

The control device 10 changes the speaker 25 that outputs the notification sound depending on the remaining distance. Therefore, the driver can recognize the distance to the merging start point 107 based on the change in position from which the notification sound is outputted.

From the mode of light emitted from the display region 27, the driver can recognize the information on the merging preparation section 103A such as the radius of curvature and the gradient. Also, the driver can recognize the information on the merging preparation section 103A such as the radius of curvature and the gradient based on the mode of the notification sound.

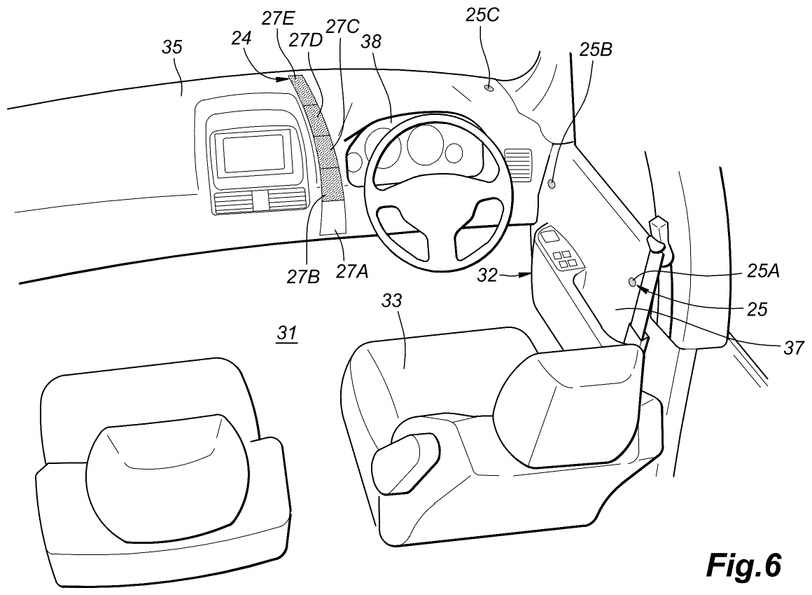

The embodiment may be modified in various ways without being limited to the above-described configuration. For example, as shown in FIG. 6, the display device 24 may be provided on the instrument panel 35 and extend in the up-down direction. In this case, the control device 10 preferably causes the at least one display region 27 that emits light to shift toward the upper side as the position of the vehicle 2 approaches the merging start point 107. In this case, the first display region 27A, the second display region 27B, the third display region 27C, the fourth display region 27D, and the fifth display region 27E are preferably arranged in this order from the lower side to the upper side.

After the vehicle 2 has merged into the main lane 101 from the merging lane 103, the control device 10 may communicate with a vehicle following the vehicle 2 on the main lane 101 to receive, from the following vehicle, following vehicle information which may include information related to acceleration and deceleration of the following vehicle or information on braking operation of the following vehicle. Then, the control device 10 may evaluate, based on the following vehicle information, the merging operation of the vehicle 2 into the main lane 101. Preferably, the control device 10 acquires the deceleration of the following vehicle based on the information related to acceleration and deceleration of the following vehicle or the information related to braking operation of the following vehicle included in the following vehicle information, and lowers the evaluation value for a greater value of the deceleration. The control device 10 may display the evaluation value on the touch panel display 23.

The above embodiment may be described as follows.

One embodiment is a driving assistance device 1 for a vehicle 2, the driving assistance device 1 comprising: a display device 24 provided in a cabin 31 of the vehicle 2 and extending in a predetermined direction, the display device 24 having multiple display regions 27 divided in an extension direction; and a control device 10 that controls the display device 24, wherein the control device 10 is configured to: acquire, on a merging lane 103 that merges with a main lane 101, a position of the vehicle 2 with respect to a merging start point 107 where a lane change from the merging lane 103 to the main lane 101 becomes possible; and cause at least one of the multiple display regions 27 to emit light based on the position of the vehicle 2 with respect to the merging start point 107, such that as the position of the vehicle 2 approaches the merging start point 107, the at least one display region 27 that emits light shifts in the extension direction.

According to this aspect, due to the display device 24 in which the at least one display region 27 that emits light shifts in the extension direction as the position of the vehicle 2 approaches the merging start point 107, the driver can easily recognize the distance from the vehicle 2 to the merging start point 107, namely, the remaining distance. Accordingly, the driver can recognize the remaining distance and make preparation for merging, such as acceleration of the vehicle 2.

In the above embodiment, the display device 24 may be provided on a door 32 constituting a side portion of the cabin 31 and may extend in a front-rear direction, and the control device 10 may cause the at least one display region 27 that emits light to shift toward a front side as the position of the vehicle 2 approaches the merging start point 107.

According to this aspect, since the at least one display region 27 that emits light shifts toward the front side depending on the remaining distance, the driver can intuitively recognize the remaining distance based on the at least one display region 27 that emits light. Also, since the display device 24 is disposed within the driver's peripheral vision, annoyance to the driver can be reduced.

In the above embodiment, the display device 24 may be provided on an instrument panel 35 constituting a front portion of the cabin 31 and may extend in an up-down direction, and the control device 10 may cause the at least one display region 27 that emits light to shift toward an upper side as the position of the vehicle 2 approaches the merging start point 107.

According to this aspect, since the display device 24 is disposed in front of the driver, the driver can easily view the display device 24.

In the above embodiment, the display device 24 may comprise: a first part 28 provided on a door 32 constituting a side portion of the cabin 31 and extending in a front-rear direction; and a second part 29 provided on an instrument panel 35 constituting a front portion of the cabin 31 and extending laterally, the front end of the first part 28 and one end of the second part 29 being disposed closer to each other, wherein the control device 10 may cause the at least one display region 27 that emits light to shift toward a front side in the first part 28 as the position of the vehicle 2 approaches the merging start point 107, and after the at least one display region 27 that emits light reaches the front end of the first part 28, the control device 10 may cause the at least one display region 27 that emits light to shift toward a lateral center of the vehicle 2 in the second part 29 as the position of the vehicle 2 approaches the merging start point 107.

According to this aspect, when the remaining distance has become small, the at least one display region 27 that emits light changes in front of the driver, and thus, the driver can more reliably recognize that the merging start point 107 is near.

In the above embodiment, the control device 10 may change at least one of color and brightness of light emitted from the at least one display region 27 based on at least one of a radius of curvature and a gradient of a merging preparation section 103A, which is a section of the merging lane 103 up to the merging start point 107.

According to this aspect, based on the mode of light emitted from the display regions 27, the driver can recognize information on the merging preparation section 103A such as the radius of curvature and the gradient.

In the above embodiment, the driving assistance device 1 may further comprise multiple speakers 25 arranged at intervals in a front-rear direction in the cabin 31 of the vehicle 2, wherein the control device 10 may select, based on the position of the vehicle 2 with respect to the merging start point 107, a speaker 25 that outputs a notification sound from among the multiple speakers 25, such that a speaker 25 disposed closer to a front side is selected as the position of the vehicle 2 approaches the merging start point 107.

According to this aspect, the driver can recognize the distance to the merging start point 107 based on the change in position from which the notification sound is outputted.

Another embodiment is a driving assistance method for a vehicle 2, wherein the driving assistance method is to be executed by a computer, wherein a display device 24 extending in a predetermined direction is provided in a cabin 31 of the vehicle 2, the display device 24 having multiple display regions 27 divided in an extension direction, the driving assistance method comprising: acquiring, on a merging lane 103 that merges with a main lane 101, a position of the vehicle 2 with respect to a merging start point 107 where a lane change from the merging lane 103 to the main lane 101 becomes possible; and causing at least one of the multiple display regions 27 to emit light based on the position of the vehicle 2 with respect to the merging start point 107, such that as the position of the vehicle 2 approaches the merging start point 107, the at least one display region 27 that emits light shifts in the extension direction.

According to this aspect, it is possible to provide a driving assistance method that enables the driver to easily recognize the distance from the vehicle 2 to the merging start point 107, namely, the remaining distance.

Another embodiment is a non-transitory computer-readable storage medium, comprising a stored program, the control program configured to cause a computer to execute a driving assistance method for a vehicle 2, wherein a display device 24 extending in a predetermined direction is provided in a cabin 31 of the vehicle 2, the display device 24 having multiple display regions 27 divided in an extension direction, the driving assistance method comprising: acquiring, on a merging lane 103 that merges with a main lane 101, a position of the vehicle 2 with respect to a merging start point 107 where a lane change from the merging lane 103 to the main lane 101 becomes possible; and causing at least one of the multiple display regions 27 to emit light based on the position of the vehicle 2 with respect to the merging start point 107, such that as the position of the vehicle 2 approaches the merging start point 107, the at least one display region 27 that emits light shifts in the extension direction.

According to this aspect, it is possible to provide a control program for causing a computer to execute a driving assistance method that can enable the driver to easily recognize the distance from the vehicle 2 to the merging start point 107, namely, the remaining distance.

1. A driving assistance device for a vehicle, the driving assistance device comprising:
a display device provided in a cabin of the vehicle and extending in a predetermined direction, the display device having multiple display regions divided in an extension direction; and
a control device that controls the display device,
wherein the control device is configured to:
acquire, on a merging lane that merges with a main lane, a position of the vehicle with respect to a merging start point where a lane change from the merging lane to the main lane becomes possible; and
cause at least one of the multiple display regions to emit light based on the position of the vehicle with respect to the merging start point, such that as the position of the vehicle approaches the merging start point, the at least one display region that emits light shifts in the extension direction.

2. The driving assistance device according to claim 1, wherein the display device is provided on a door constituting a side portion of the cabin and extends in a front-rear direction, and
the control device causes the at least one display region that emits light to shift toward a front side as the position of the vehicle approaches the merging start point.

3. The driving assistance device according to claim 1, wherein the display device is provided on an instrument panel constituting a front portion of the cabin and extends in an up-down direction, and
the control device causes the at least one display region that emits light to shift toward an upper side as the position of the vehicle approaches the merging start point.

4. The driving assistance device according to claim 1, wherein the display device comprises:
a first part provided on a door constituting a side portion of the cabin and extending in a front-rear direction; and
a second part provided on an instrument panel constituting a front portion of the cabin and extending laterally, the front end of the first part and one end of the second part being disposed close to each other,
and wherein the control device causes the at least one display region that emits light to shift toward a front side in the first part as the position of the vehicle approaches the merging start point, and after the at least one display region that emits light reaches the front end of the first part, the control device causes the at least one display region that emits light to shift toward a lateral center of the vehicle in the second part as the position of the vehicle approaches the merging start point.

5. The driving assistance device according to claim 2, wherein the control device changes at least one of color and brightness of light emitted from the at least one display region based on at least one of a radius of curvature and a gradient of a merging preparation section which is a section of the merging lane up to the merging start point.

6. The driving assistance device according to claim 1, further comprising multiple speakers arranged at intervals in a front-rear direction in the cabin of the vehicle,
wherein the control device selects, based on the position of the vehicle with respect to the merging start point, a speaker that outputs a notification sound from among the multiple speakers, such that a speaker disposed closer to a front side is selected as the position of the vehicle approaches the merging start point.

7. The driving assistance device according to claim 6, wherein the control device changes a mode of sound outputted from the multiple speakers based on at least one of a radius of curvature and a gradient of a merging preparation section which is a section of the merging lane up to the merging start point.

8. A driving assistance method for a vehicle, wherein the driving assistance method is to be executed by a computer,
wherein a display device extending in a predetermined direction is provided in a cabin of the vehicle, the display device having multiple display regions divided in an extension direction,
the driving assistance method comprising:
acquiring, on a merging lane that merges with a main lane, a position of the vehicle with respect to a merging start point where a lane change from the merging lane to the main lane becomes possible; and
causing at least one of the multiple display regions to emit light based on the position of the vehicle with respect to the merging start point, such that as the position of the vehicle approaches the merging start point, the at least one display region that emits light shifts in the extension direction.

9. A non-transitory computer-readable storage medium, comprising a stored control program, the control program configured to cause a computer to execute a driving assistance method for a vehicle,
wherein a display device extending in a predetermined direction is provided in a cabin of the vehicle, the display device having multiple display regions divided in an extension direction,
the driving assistance method comprising:
acquiring, on a merging lane that merges with a main lane, a position of the vehicle with respect to a merging start point where a lane change from the merging lane to the main lane becomes possible,
causing at least one of the multiple display regions to emit light based on the position of the vehicle with respect to the merging start point, such that as the position of the vehicle approaches the merging start point, the at least one display region that emits light shifts in the extension direction.
